(19) United States
(12) Patent Application Publication
(10) Pub. No.: US 2015/0277729 A1
(43) Pub. Date: Oct. 1, 2015

(54) ELECTRONIC WHITEBOARD DEVICE, INPUT SUPPORT METHOD OF ELECTRONIC WHITEBOARD, AND COMPUTER-READABLE RECORDING MEDIUM

(71) Applicant: NEC Corporation, Tokyo (JP)

(72) Inventor: Hiroyuki KOBAYASHI, Tokyo (JP)

(73) Assignee: NEC Corporation

(21) Appl. No.: 14/665,728

(22) Filed: Mar. 23, 2015

(30) Foreign Application Priority Data
Apr. 1, 2014 (JP) 2014-075453

(51) Int. Cl. G06F 3/0484; H04L 29/08

(52) U.S. Cl. CPC G06F 3/04847; G06F 3/04845; G06F 3/04842; H04L 67/10

(57) ABSTRACT

Disclosed are an electronic whiteboard device and the like, which can automatically execute position adjustment between a frame object and another object, while allowing a user to insert a space within the frame object by a simplified operation. An electronic whiteboard device is provided with: an object setting unit which places a frame object for use in grouping information on an electronic whiteboard; a frame object discriminating unit which discriminates whether an object existing in an area for which space insertion is requested on the electronic whiteboard is the frame object; and a space insertion processing unit which enlarges the discriminated frame object in accordance with a space to be inserted, and changes a display position of the discriminated frame object so that the enlarged frame object does not overlap another object placed in a vicinity of the frame object.

This application is based upon and claims the benefit of priority from Japanese Patent Application No. 2014-075453, filed on Apr. 1, 2014, the disclosure of which is incorporated herein in its entirety by reference.

### TECHNICAL FIELD

The present invention relates to an electronic whiteboard device, an input support method of an electronic whiteboard, and a computer-readable recording medium.

### BACKGROUND ART

In recent years, there has been proposed an electronic whiteboard using a communication network (hereinafter, abbreviated as a “network”) in order to allow a number of users in remote places to discuss via personal computers (hereinafter, called as “PCs”) and also via terminal devices such as smartphones or tablet devices in these days. The electronic whiteboard is a virtual whiteboard provided on a network. Each user can freely place objects such as texts and figures (such as arrows) on a whiteboard displayed on a screen of his or her terminal device. With use of the electronic whiteboard, the users can share information online and discuss among themselves in the same manner as the case of using a physical whiteboard.

An electronic whiteboard is configured so that the size of an area to be drawn by the users on an electronic whiteboard can be changed. The users can add new objects by enlarging a drawing area. However, when multitudes of objects have already been drawn within a drawing area, whereby there is no space in which an object is newly added, it is necessary to insert an additional space within the drawing area.

As a method for inserting an additional space, there has been known a method, in which all the objects existing at a location where insertion is designated are moved by a designated distance. In this method, however, it is difficult to efficiently place the objects.

Patent Literature 1 (International Publication No. 2008/132977) discloses a method for efficiently placing a new object within a drawing area, in which objects have already been drawn. Specifically, in the method disclosed in Patent Literature 1, when a new object is drawn, first of all, overlapping between the new object and an existing object is detected. Subsequently, the display position of the existing object is changed so that these objects do not overlap each other, based on the detected overlapping, whereby the existing object is seemingly moved from the user side. Thus, the new object is efficiently placed.

Further, in an electronic whiteboard, an object serving as a frame and viewing like a frame (hereinafter, in this application, called as a “frame object”) may be drawn for the purpose of grouping the drawn objects. In this case, various objects are placed within the frame object. For instance, when a frame object representing a group is drawn, the names of members of the group are placed within the frame object. Further, when a frame object representing a technical field is drawn, product ideas are placed within the frame object.

When such a frame object is drawn, it may be necessary to insert an additional space within the frame. Use of the method disclosed in Patent Literature 1 makes it possible to easily insert a space, while moving the other objects within the frame.

An object or objects other than a frame object to be enlarged may be placed on an electronic whiteboard. In view of the above, when a frame object is enlarged, it may be necessary to adjust a positional relationship with respect to the other object(s) placed in the periphery of the frame object.

However, in the method disclosed in Patent Literature 1, such position adjustment between a frame object and another object as described above is not performed. Therefore, there is a problem that the method disclosed in Patent Literature 1 is applicable only to a case where there exists a single frame object. Further, there is another problem in the method disclosed in Patent Literature 1 that it is necessary to accurately designate an insertion position. This makes it difficult for the user to perform an insertion operation.

The invention is made in order to solve the above problems, and a main object of the invention is to provide an electronic whiteboard device and the like, which enable to automatically execute position adjustment between a frame object and another object, while allowing a user to insert a space within the frame object by a simplified operation on an electronic whiteboard.

### SUMMARY

A first aspect of the invention is directed to an electronic whiteboard device including:

an object setting unit which places a frame object for use in grouping information on an electronic whiteboard displayed on a screen;

a frame object discriminating unit which discriminates whether an object existing in an area for which space insertion is requested on the electronic whiteboard is the frame object; and

a space insertion processing unit which enlarges the discriminated frame object in accordance with a space to be inserted, and changes a display position of the discriminated frame object so that the enlarged frame object does not overlap another object placed in a vicinity of the frame object.

A second aspect of the invention is directed to an input support method of an electronic whiteboard, the method including:

(a) placing a frame object for use in grouping information on an electronic whiteboard displayed on a screen;

(b) discriminating whether an object existing in an area for which space insertion is requested on the electronic whiteboard is the frame object; and

(c) enlarging the frame object discriminated in the step (b) in accordance with a space to be inserted, and changing a display position of the frame object in such a manner that the enlarged frame object does not overlap another object placed in a vicinity of the frame object.

A third aspect of the invention is directed to a non-transitory computer-readable recording medium storing a program which causes a computer to execute:

(a) a function of placing a frame object for use in grouping information on an electronic whiteboard displayed on a screen;

(b) a function of discriminating whether an object existing in an area for which space insertion is requested on the electronic whiteboard is the frame object; and

(c) a function of enlarging the frame object discriminated in the function (b) in accordance with a space to be inserted, and changing a display position of the frame object in such a manner that the enlarged frame object does not overlap another object placed in a vicinity of the frame object.

According to the invention as described above, it is possible to automatically execute position adjustment between a frame object and another object, while allowing a user to insert a space within the frame object by a simplified operation on an electronic whiteboard.

### BRIEF DESCRIPTION OF THE DRAWINGS

Exemplary features and advantages of the present invention will become apparent from the following detailed description when taken with the accompanying drawings in which:

FIG. 1 is a block diagram illustrating a configuration of an electronic whiteboard device in an exemplary embodiment of the invention;

FIG. 2 is a block diagram specifically illustrating a configuration of the electronic whiteboard device in the exemplary embodiment of the invention;

FIG. 3 is a diagram illustrating an example of object data to be stored in a storage unit illustrated in FIG. 2;

FIG. 4 is a flowchart illustrating an operation to be performed when a space insertion process is carried out by the electronic whiteboard device in the exemplary embodiment of the invention;

FIG. 5A is a diagram exemplifying a state of an electronic whiteboard before the space insertion process is started;

FIG. 5B is a diagram exemplifying a state of the electronic whiteboard after the space insertion process is ended;

FIG. 6A is a diagram exemplifying object data before the space insertion process is started;

FIG. 6B is a diagram exemplifying the object data after the space insertion process is ended;

FIG. 7 is a flowchart illustrating an operation to be performed when a frame object discrimination process is carried out by the electronic whiteboard device in the exemplary embodiment of the invention;

FIG. 8A is a diagram illustrating a state before insertion in a general space insertion process;

FIG. 8B is a diagram illustrating a state at the time of insertion in the general space insertion process;

FIG. 8C is a diagram illustrating a state after insertion in the general space insertion process;

FIG. 9A is a diagram illustrating a state before insertion in the space insertion process in the exemplary embodiment of the invention;

FIG. 9B is a diagram illustrating a state at the time of insertion in the space insertion process in the exemplary embodiment of the invention;

FIG. 9C is a diagram illustrating a state after insertion in the space insertion process in the exemplary embodiment of the invention;

FIG. 10A is a diagram illustrating a state before insertion in the space insertion process in the exemplary embodiment of the invention;

FIG. 10B is a diagram illustrating a state at the time of insertion in the space insertion process in the exemplary embodiment of the invention;

FIG. 10C is a diagram illustrating a state after insertion in the space insertion process in the exemplary embodiment of the invention;

FIG. 11A is a diagram illustrating a state at the time of insertion in a space insertion process in a variation of space insertion;

FIG. 11B is a diagram illustrating a state after insertion in the space insertion process in the variation of space insertion;

FIG. 12A is a diagram illustrating a state at the time of insertion in a space insertion process in another variation of space insertion;

FIG. 12B is a diagram illustrating a state after insertion in the space insertion process in the another variation of space insertion; and

FIG. 13 is a block diagram illustrating an example of a computer that implements the electronic whiteboard device in the exemplary embodiment of the invention.

### EXEMPLARY EMBODIMENT

### Outline of Invention

According to the invention, it is discriminated whether an object is a frame object that is used as a frame, or an object that is not used as a frame when a space insertion process is carried out, and the space insertion process is carried out based on a discrimination result.

Further, an object used as a frame is likely to include another object. In view of the above, when an object includes another object, it is necessary to discriminate whether the object is used as a frame for grouping other objects, or the object is a simple frame-like figure.

Further, it is often the case that an object used as a frame for grouping has a predetermined size or larger, and is likely to include two or more of other objects. Further, it is often the case that an object used as a frame for grouping is likely to include multitudes of objects of specific kinds. On the other hand, it is presumed that objects of different shapes such as arrows or rectangular shapes are often placed in a simple frame-like figure.

In view of the above, according to the invention, for instance, when the size of a target object is equal to or larger than a predetermined value, when the target object includes other objects of a predetermined number or more, and when the ratio of objects of the same kind included in the target object is equal to or larger than a predetermined value, the target object is discriminated as a frame object. In the exemplary embodiment, the size of an object used as a frame is enlarged by a designated ratio. This makes it possible to insert a space within the frame.

### Exemplary Embodiment

Next, a detailed explanation will be given for exemplary embodiments with reference to the drawings.

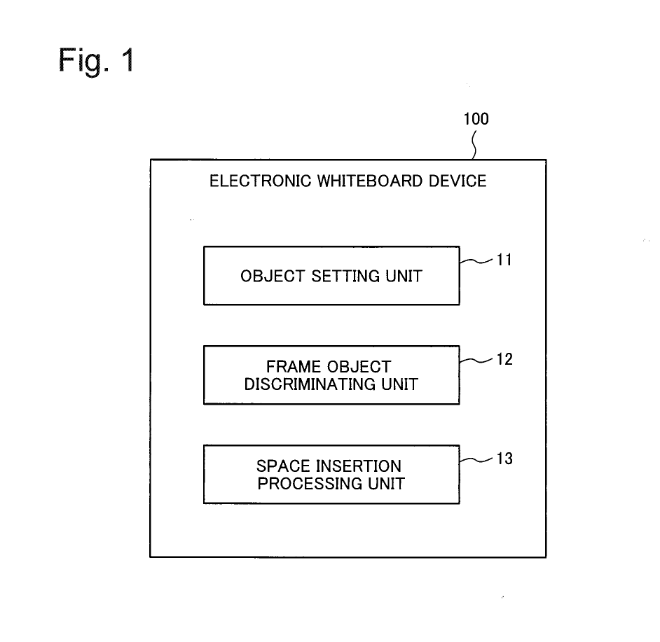

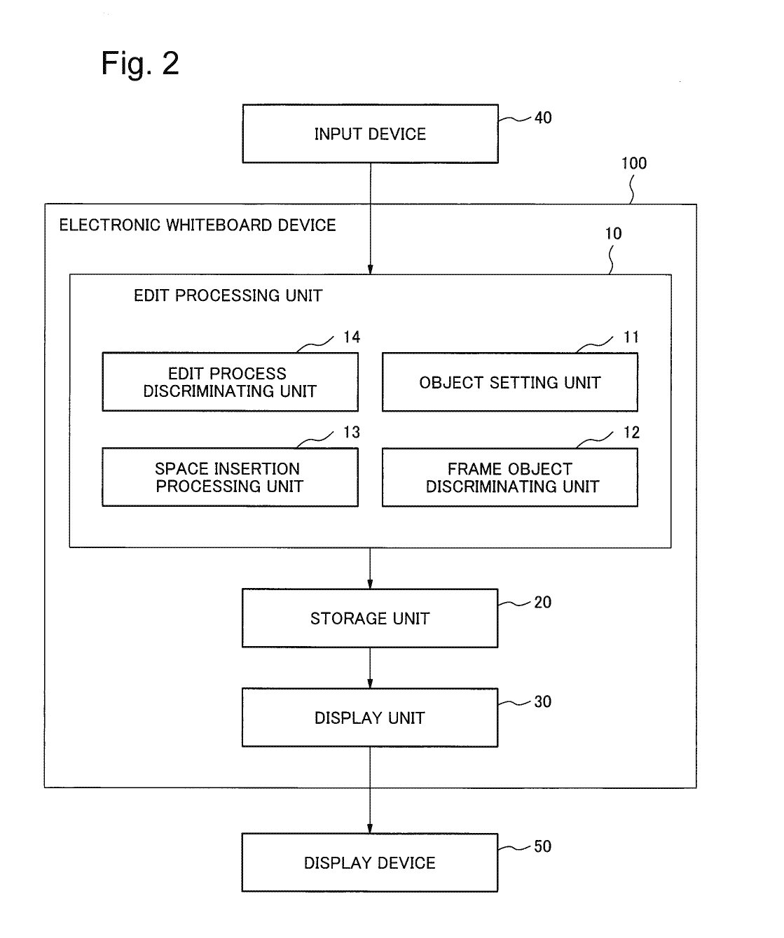

In the following, an electronic whiteboard device and the like in the exemplary embodiment of the invention are described referring to FIG. 1 and FIG. 2.

### Configuration of Device

First of all, a configuration of an electronic whiteboard device in an exemplary embodiment is described using FIG. 1. FIG. 1 is a block diagram illustrating a configuration of the electronic whiteboard device in the exemplary embodiment of the invention.

As illustrated in FIG. 1, an electronic whiteboard device 100 in the exemplary embodiment is a device for displaying a virtual whiteboard on a screen. The electronic whiteboard device 100 is provided with an object setting unit 11, a frame object discriminating unit 12, and a space insertion processing unit 13.

The object setting unit 11 places a frame object for use in grouping information on an electronic whiteboard (not illustrated in FIG. 1) displayed on a screen. The frame object discriminating unit 12 determines whether an object existing in an area for which space insertion is requested (hereinafter, called as a “space insertion area”) on the electronic whiteboard is a frame object.

The space insertion processing unit 13 enlarges the discriminated frame object in accordance with a space to be inserted, and changes the display position of the frame object so that the enlarged frame object does not overlap another object placed in the periphery of the frame object.

As described above, in the exemplary embodiment, it is discriminated whether an object is a frame object at the time of space insertion, and only the frame object is enlarged. An object or objects other than the frame object are moved so that the other objects do not overlap the enlarged frame object. Therefore, in the exemplary embodiment, it is possible to insert a space within a frame object by a simplified operation on an electronic whiteboard. Further, at the same time, position adjustment between the frame object and the other objects is automatically performed.

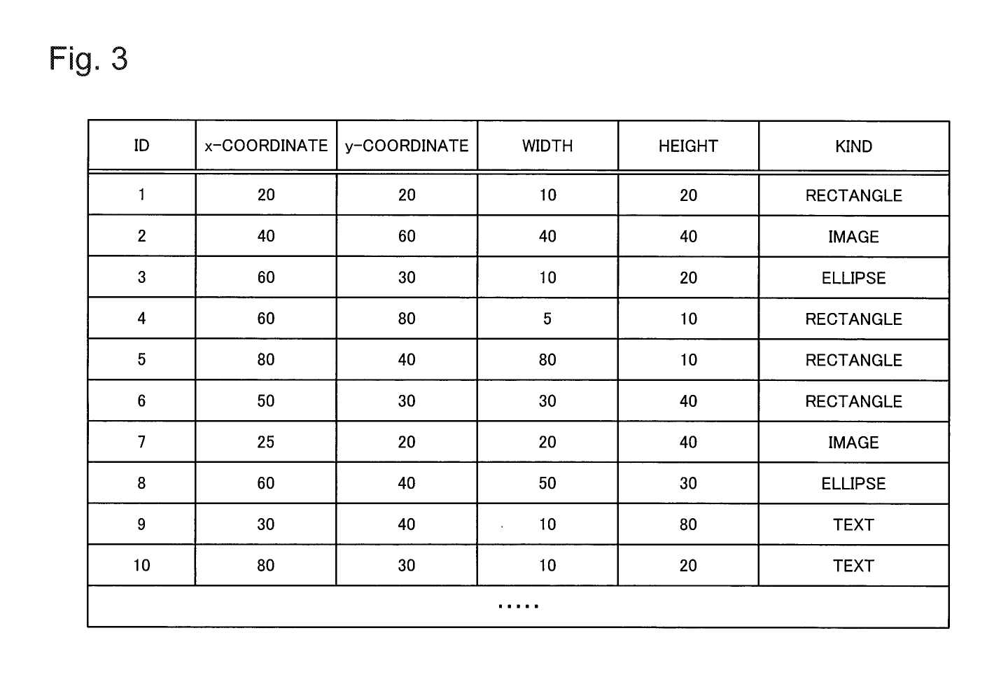

A configuration of the electronic whiteboard device in the exemplary embodiment is described in more detail using FIG. 2 and FIG. 3. FIG. 2 is a block diagram specifically illustrating a configuration of the electronic whiteboard device in the exemplary embodiment of the invention. FIG. 3 is a diagram illustrating an example of object data to be stored in a storage unit illustrated in FIG. 2.

As illustrated in FIG. 2, in the exemplary embodiment, the electronic whiteboard device 100 is connected to an input device 40 and to a display device 50. The input device 40 is an input device such as a mouse, a pointing device, a touch display, or a keyboard. The user is allowed to perform space insertion, and further, operations of adding, moving, and deleting an object on an electronic whiteboard via the input device 40. The display device 50 is a device for displaying an electronic whiteboard on a screen, and is a liquid crystal display, for instance. The input device 40 and the display device 50 may be incorporated as part of the electronic whiteboard device 100.

Further, as illustrated in FIG. 2, in the exemplary embodiment, the electronic whiteboard device 100 is provided with an edit processing unit 10, a storage unit 20, and a display unit 30.

Among these units, the storage unit 20 stores object data of each of the objects to be drawn on an electronic whiteboard. Specifically, as illustrated in FIG. 3, object data includes data such as the kinds of objects (e.g. a text, a rectangle, an ellipse, and an image), the positions of objects (x-coordinate and y-coordinate), and the sizes of objects (width and height) for each object. FIG. 3 is a diagram illustrating an example of object data for use in the exemplary embodiment.

The display unit 30 displays an electronic whiteboard on a screen of the display device 50, using the object data stored in the storage unit 20. Further, the display unit 30 reflects updated contents on the screen, when the object data stored in the storage unit 20 is updated.

The edit processing unit 10 is provided with the object setting unit 11, the frame object discriminating unit 12, and the space insertion processing unit 13 as described above. The edit processing unit 10 is further provided with an edit process discriminating unit 14, in addition to these units.

The edit process discriminating unit 14 in the edit processing unit 10 specifies operation contents, when an operation is input from the input device 40. For instance, when the user designates space insertion using the input device 40, and further performs a drag operation of designating two points on a screen, the edit process discriminating unit 14 specifies the position and the range of a space to be inserted.

Specifically, as will be described later, the edit process discriminating unit 14 specifies the value of y-coordinate at a drag start point and the value of y-coordinate at a drag end point for specifying the position and the range of a space to be inserted. The edit process discriminating unit 14 outputs the specified position and the specified range of the space to the space insertion processing unit 13. In the exemplary embodiment, it is assumed that the uppermost and leftmost point on a screen is defined as the origin, an axis along a vertical direction (up and down direction) of the screen is defined as the y-axis, and an axis along a horizontal direction (left and right direction) of the screen is defined as the x-axis.

Further, when the user performs an operation of adding, moving, or deleting an object using the input device 40, the edit process discriminating unit 14 specifies a target object and outputs information relating to the specified object and information necessary for execution of the operation to the object setting unit 11.

In the exemplary embodiment, the object setting unit 11 places not only the frame object but also the other objects in accordance with the information output from the edit process discriminating unit 14. The object setting unit 11 also executes an operation of moving or deleting an object in accordance with the information output from the edit process discriminating unit 14. The object setting unit 11 updates the object data stored in the storage unit 20 in accordance with an execution result, when an operation of adding, moving, or deleting an object is executed.

In the exemplary embodiment, when discrimination of a frame object is instructed from the space insertion processing unit 13, the frame object discriminating unit 12 acquires object data of an object to be discriminated from the storage unit 20. Then, the frame object discriminating unit 12 determines whether the target object whose object data has been acquired corresponds to a frame object. Further, the frame object discriminating unit 12 notifies a discrimination result to the space insertion processing unit 13.

Specifically, the frame object discriminating unit 12 discriminates that a target object that satisfies all the following conditions (1) to (4) is a frame object.

Condition (1): The shape of a target object is a rectangle.

Condition (2): The area of the target object is equal to or smaller than a threshold value.

Condition (3): The number of objects placed within the target object exceeds a threshold number.

Condition (4): The ratio of objects of the same kind among the objects placed within the target object is equal to or larger than a threshold value.

When the position and the range of a space to be inserted are output from the edit process discriminating unit 14, the space insertion processing unit 13 specifies an object existing in the area for which space insertion is requested. Specifically, when space insertion is performed based on designating two points on a screen by a drag operation, the space insertion processing unit 13 specifies an object that overlaps an area defined by the designated two points.

Then, the space insertion processing unit 13 instructs the frame object discriminating unit 12 to discriminate whether the specified object is a frame object, and receives a discrimination result. Thereafter, the space insertion processing unit 13 acquires, from the storage unit 20, object data of the specified object.

The space insertion processing unit 13 compares the position and the size of an object other than the frame object, and the position and the range of a space to be inserted; and calculates a moving amount of the object, based on a comparison result. Further, the space insertion processing unit 13 updates the object data of the object to be moved in the storage unit 20, based on the calculated moving amount.

The space insertion processing unit 13 calculates an enlargement amount of the frame object discriminated by the frame object discriminating unit 12, based on the position and the range of the space to be inserted, and enlarges the frame object based on a calculation result.

Specifically, when space insertion is performed by a drag operation of designating two points on a screen, the frame object is enlarged by a distance between the designated two points in a setting direction (e.g. the y-axis direction).

When the frame object is enlarged, the space insertion processing unit 13 updates the object data of the frame object to be enlarged in the storage unit 20, based on the enlargement amount.

### Operation of Device

Next, an operation of the electronic whiteboard device 100 in the exemplary embodiment of the invention is described using the drawings. In the following description, FIG. 1 to FIG. 3 are referred to as necessary. Further, in the exemplary embodiment, operating the electronic whiteboard device 100 makes it possible to implement an input support method of an electronic whiteboard. Therefore, description about the input support method of an electronic whiteboard in the exemplary embodiment is substituted by describing the following operation of the electronic whiteboard device 100.

In the exemplary embodiment, a space insertion process, and a frame object discrimination process to be carried out in association with the space insertion process are the main features of the electronic whiteboard device 100. Therefore, in the following, the two processes are mainly described.

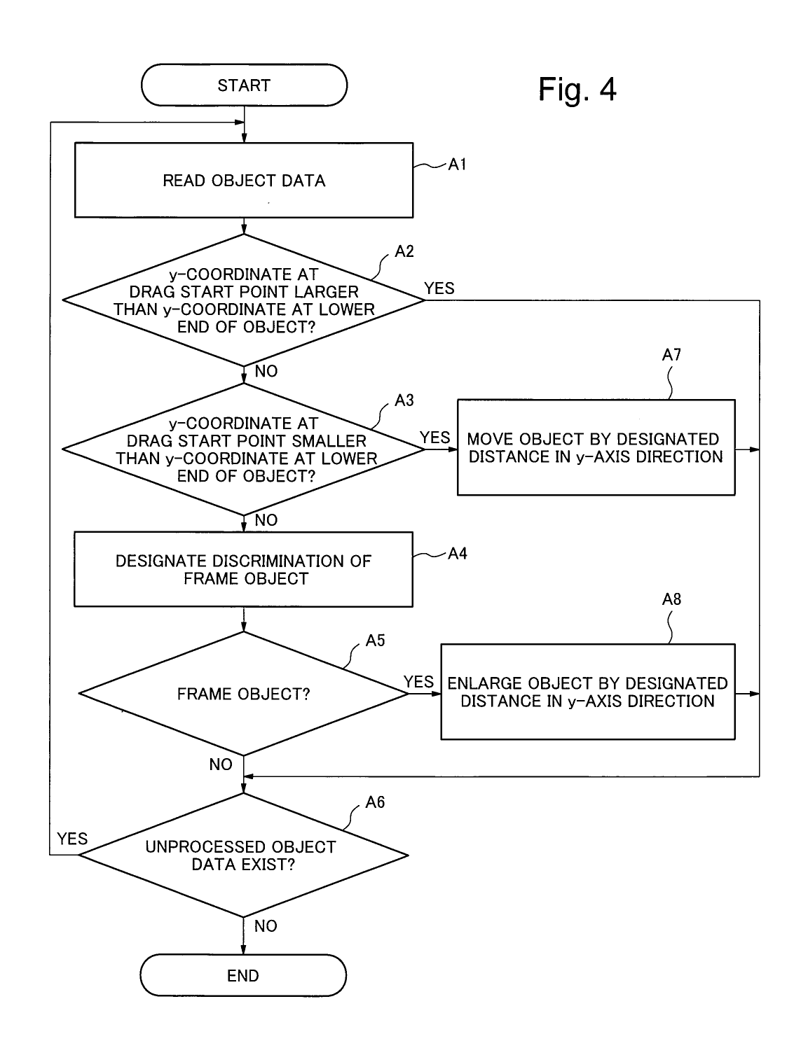

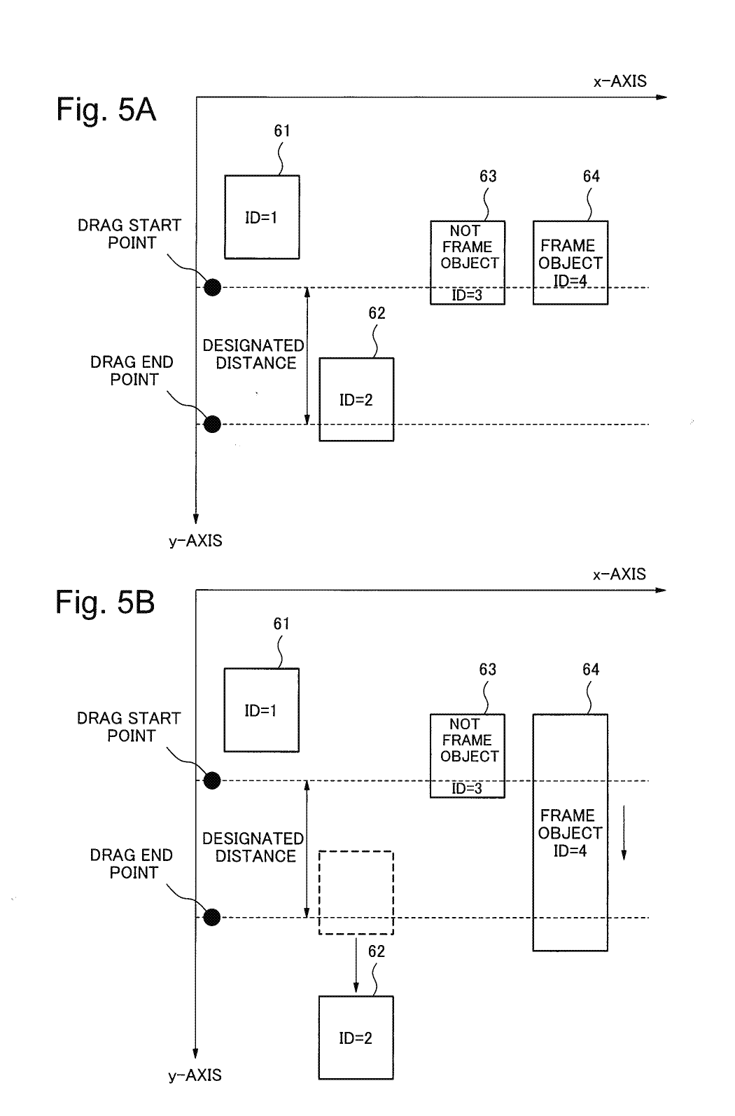

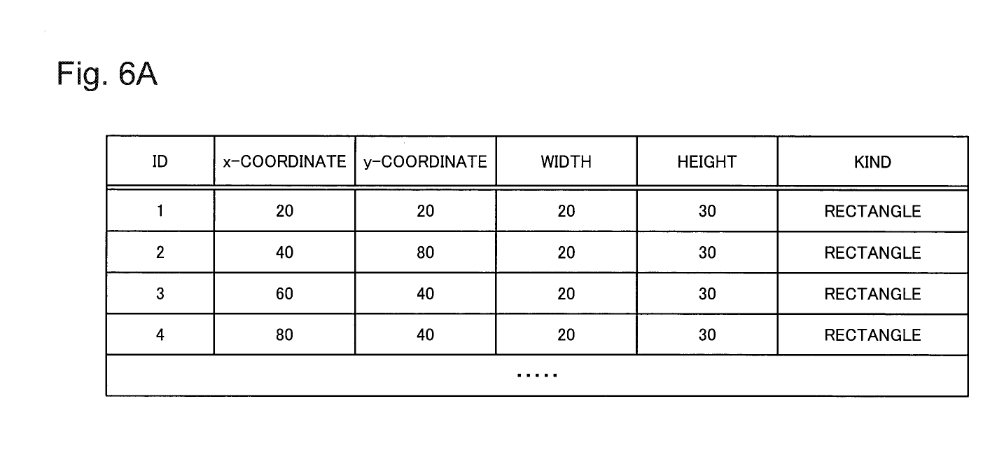

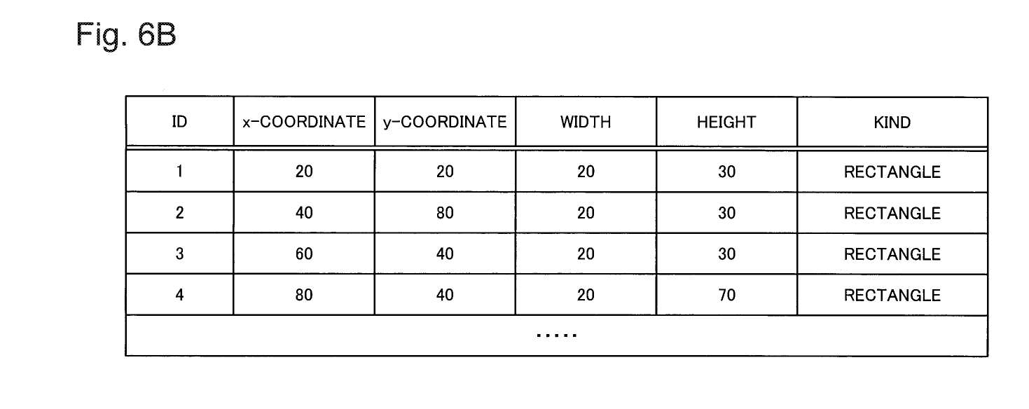

First of all, the space insertion process is described using FIG. 4 to FIG. 6B. FIG. 4 is a flowchart illustrating an operation to be performed when the space insertion process is carried out by the electronic whiteboard device in the exemplary embodiment of the invention. FIG. 5A is a diagram exemplifying a state of an electronic whiteboard before the space insertion process is started. FIG. 5B is a diagram exemplifying a state of the electronic whiteboard after the space insertion process is ended. FIG. 6A is a diagram exemplifying object data before the space insertion process is started. FIG. 6B is a diagram exemplifying the object data after the space insertion process is ended.

First of all, it is assumed that the user designates space insertion using the input device 40, and performs a drag operation of designating a rectangular area based on an input of two points on a screen. Further, it is assumed that by the aforementioned operation, the edit process discriminating unit 14 specifies the value of y-coordinate at a drag start point and the value of y-coordinate at a drag end point, and outputs the specified values to the space insertion processing unit 13 as the position and the range of the space.

As illustrated in FIG. 4, first of all, upon receiving coordinate values from the edit process discriminating unit 14, the space insertion processing unit 13 reads object data as an arbitrary object to be processed from the storage unit 20 (Step A1).

Subsequently, the space insertion processing unit 13 determines whether the y-coordinate value at the drag start point is larger than the y-coordinate value at a lower end of the object “(y-coordinate value of object)+(height)” (Step A2).

As a result of the determination in Step A2, when the y-coordinate value at the drag start point is larger than the y-coordinate value at the lower end of the object, the space insertion processing unit 13 executes Step A6 to be described later, without changing the object to be processed. This is because the object to be processed corresponds to an object 61 (ID=1) illustrated in FIG. 5A and FIG. 5B. ID represents an identifier.

On the other hand, as a result of the determination in Step A2, when the y-coordinate value at the drag start point is not larger than the y-coordinate value at the lower end of the object, the space insertion processing unit 13 determines whether the y-coordinate value at the drag start point is smaller than the y-coordinate value at the lower end of the object (Step A3).

As a result of the determination in Step A3, when the y-coordinate value at the drag start point is smaller than the y-coordinate value at the lower end of the object, the space insertion processing unit 13 moves the object to be processed by the designated distance in the y-axis positive (plus) direction (Step A7). This is because the object to be processed corresponds to an object 62 (ID=2) illustrated in FIG. 5A and FIG. 5B. The designated distance is calculated by subtracting the y-coordinate value at the drag start point from the y-coordinate value at the drag end point.

On the other hand, as a result of the determination in Step A3, when the y-coordinate value at the drag start point is not smaller than the y-coordinate value at the lower end of the object, the space insertion processing unit 13 instructs the frame object discriminating unit 12 to discriminate whether the object to be processed is a frame object, and acquires a discrimination result (Step A4).

Subsequently, the space insertion processing unit 13 determines whether the object to be processed is discriminated as a frame object from the discrimination result (Step A5). As a result of the determination in Step A5, when the object to be processed is not discriminated as a frame object, the space insertion processing unit 13 executes Step A6 to be described later, without changing the object to be processed. This is because the object to be processed corresponds to an object 63 (ID=3) illustrated in FIG. 5A and FIG. 5B.

On the other hand, as a result of the determination in Step A5, when the object to be processed is discriminated as a frame object, the space insertion processing unit 13 enlarges the object by a designated distance in the y-axis positive (plus) direction (Step A8). In this case, the object to be processed corresponds to an object 64 (ID=4) illustrated in FIG. 5A and FIG. 5B.

When Yes in Step A2, or when No in Step A5, or when Step A7 or A8 is executed, the space insertion processing unit 13 determines whether there exists unprocessed object data (Step A6).

As a result of the determination in Step A6, when there does not exist unprocessed object data, the space insertion processing unit 13 finishes the process. On the other hand, as a result of the determination in Step A6, when there exists unprocessed object data, the space insertion processing unit 13 executes Step A1 again. The aforementioned Steps A1 to A7 may also be applied to a case, in which space insertion is performed in the x-axis positive direction. In this case, only a frame object can be enlarged in the x-axis positive direction and in the x-axis negative (minus) direction.

Further, when an object is moved, or when a frame object is enlarged, the space insertion processing unit 13 updates the object data stored in the storage unit 20. For instance, it is assumed that space insertion is designated between the y-coordinate value 60 and the y-coordinate value 100 when the object data illustrated in FIG. 6A is held. In this case, the object whose object ID is 4 is discriminated as a frame object. Therefore, as illustrated in FIG. 6B, the object whose object ID is 4 is enlarged.

The aforementioned space insertion process has been described in the case, in which the drag direction coincides with the y-axis positive direction in one instance. Alternatively, when the drag direction coincides with the y-axis negative direction, it is possible to implement a process of enlarging a frame in the y-axis negative direction in the same manner as the space insertion process.

Next, a frame object extraction process (a determination process) is described using FIG. 7. FIG. 7 is a flowchart illustrating an operation to be performed when a frame object discrimination process is carried out by the electronic whiteboard device in the exemplary embodiment of the invention.

As illustrated in FIG. 7, first of all, the frame object discriminating unit 12 determines whether the shape of the designated object is rectangle (Step B1). As a result of the determination in Step B1, when the shape of the designated object is not rectangle, the frame object discriminating unit 12 discriminates that the designated object is not a frame object, and notifies the discrimination result to the space insertion processing unit 13 (Step B10).

As a result of the determination in Step B1, when the shape of the designated object is rectangle, the frame object discriminating unit 12 determines whether the area (width×height) of the designated object is equal to or smaller than a predetermined value (Step B2). As a result of the determination in Step B2, when the area of the designated object is equal to or smaller than the predetermined value, the frame object discriminating unit 12 executes Step B10, and notifies the space insertion processing unit 13 that the designated object is different from a frame object.

As a result of the determination in Step B2, when the area of the designated object is larger than the predetermined value, the frame object discriminating unit 12 executes reading of object data of an arbitrary object drawn on the electronic whiteboard from the storage unit 20 (Step B3).

Subsequently, the frame object discriminating unit 12 determines whether the read object is included in the designated object (Step B4). As a result of the determination in Step B4, when the read object is included in the designated object, the read object is included in an inclusion object list (Step B5).

Specifically, in Step B5, the frame object discriminating unit 12 determines that a read object is included in a designated object when all the following conditions (a) to (d) are satisfied.

Condition (a): The x-coordinate value of a designated object is smaller than the x-coordinate value of a read object.

Condition (b): The y-coordinate value of the designated object is smaller than the y-coordinate value of the read object.

Condition (c): The value (x-coordinate value+width) of the designated object is larger than the value (x-coordinate value+width) of the read object.

Condition (d): The value (y-coordinate value+height) of the designated object is larger than the value (y-coordinate value+height) of the read object.

As a result of the determination in Step B4, when the read object is not included in the designated object, or when Step B5 is executed, the frame object discriminating unit 12 determines whether there exists unprocessed object data (Step B6).

As a result of the determination in Step B6, when there exists unprocessed object data, the frame object discriminating unit 12 executes Step B3 again. On the other hand, as a result of the determination in Step B6, when there does not exist unprocessed object data, the frame object discriminating unit 12 determines whether the number of objects included in the inclusion object list is equal to or smaller than a predetermined number (Step B7).

As a result of the determination in Step B7, when the number of objects included in the inclusion object list is equal to or smaller than the predetermined number, the frame object discriminating unit 12 executes Step B10, and notifies the space insertion processing unit 13 that the designated object is different from a frame object.

On the other hand, as a result of the determination in Step B7, when the number of objects included in the inclusion object list is larger than the predetermined number, the frame object discriminating unit 12 determines whether the ratio of objects of the same kind among the objects included in the inclusion object list is equal to or larger than a predetermined value (Step B8).

As a result of the determination in Step B8, when the ratio of objects of the same kind is smaller than the predetermined value, the frame object discriminating unit 12 executes Step B10, and notifies the space insertion processing unit 13 that the designated object is different from a frame object.

On the other hand, as a result of the determination in Step B8, when the ratio of objects of the same kind is equal to or larger than the predetermined value, the frame object discriminating unit 12 discriminates that the designated object is a frame object (Step B9). Subsequently, the frame object discriminating unit 12 notifies the space insertion processing unit 13 that the designated object is a frame object.

### Advantageous Effects of Exemplary Embodiment

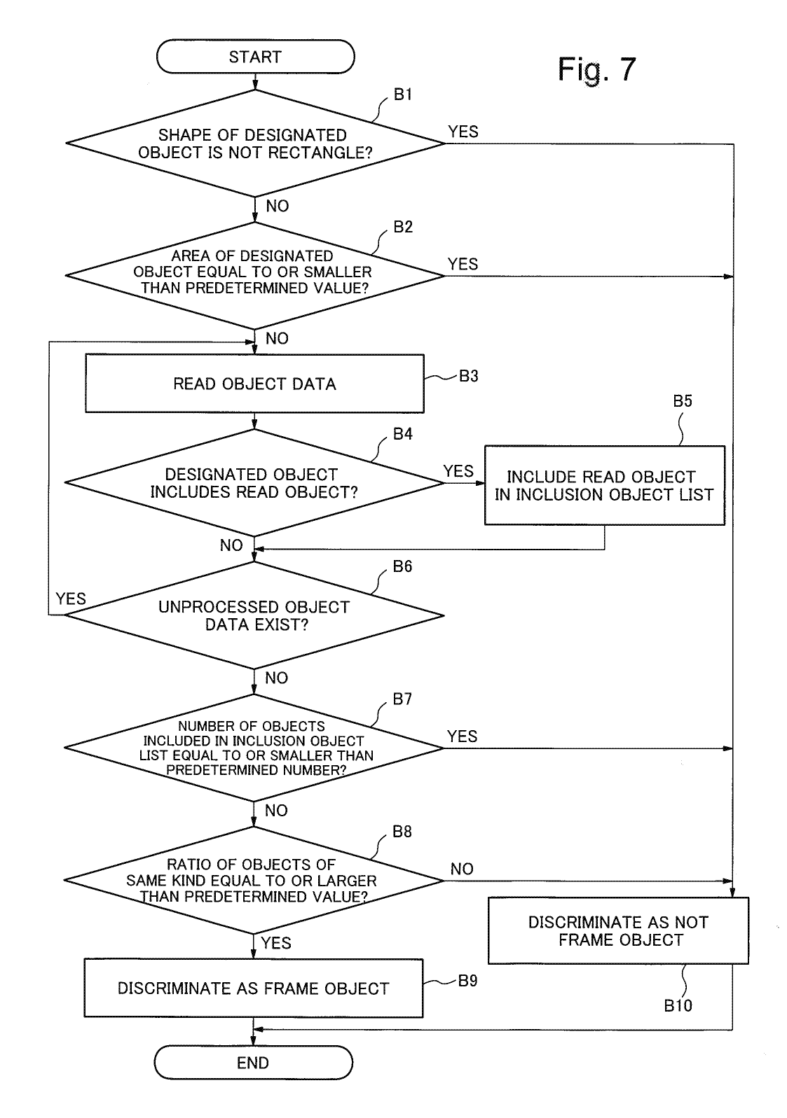

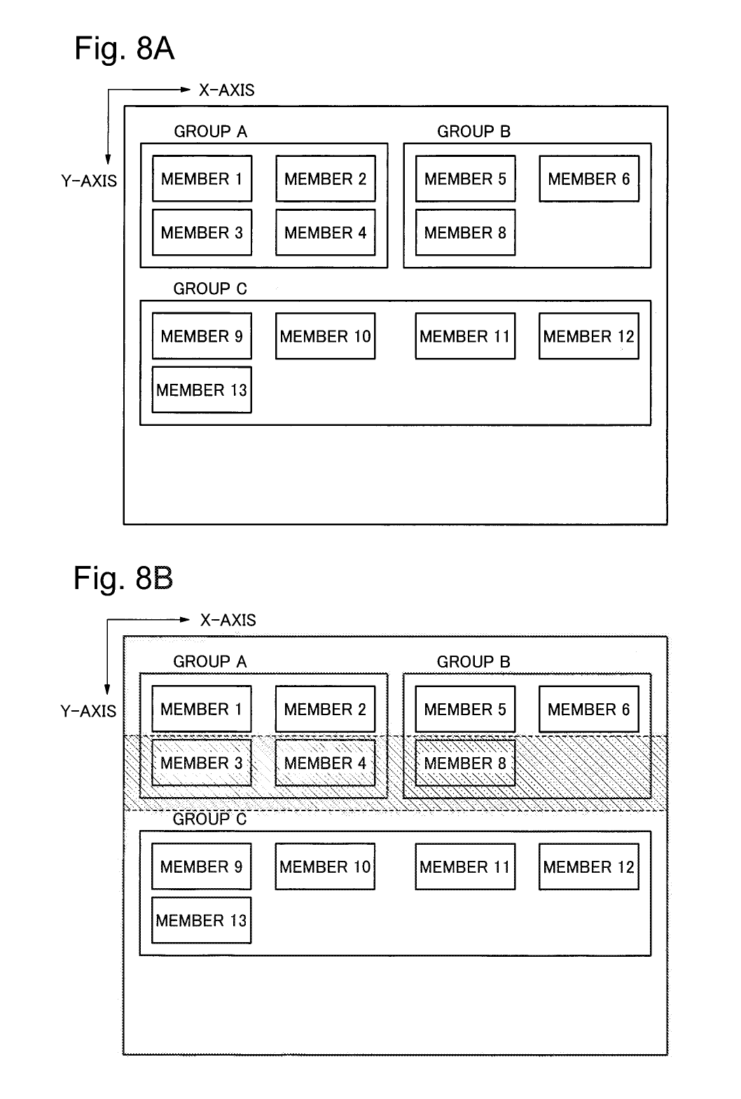

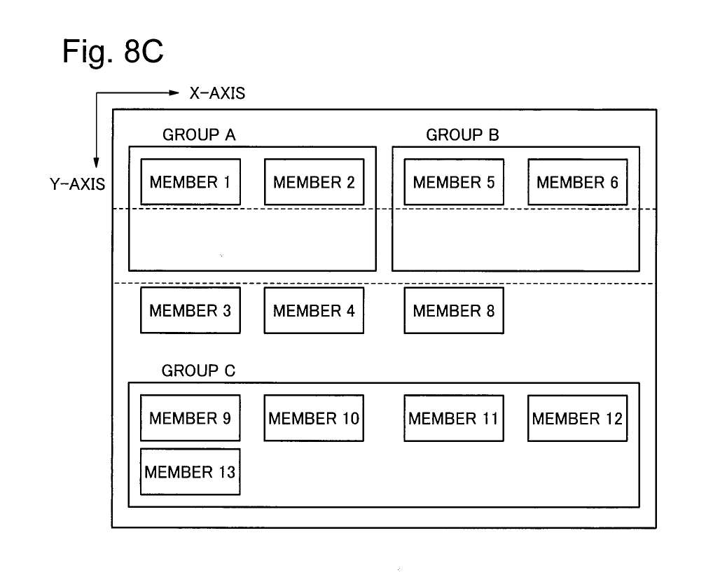

As described above, according to the exemplary embodiment, when an object is used as a frame for the purpose of grouping on an electronic whiteboard, even when a plurality of objects are located in proximity to one another, it is possible to advantageously insert a space within the frame. This is because it is discriminated whether the object is a frame object to be used as a frame when space insertion is performed. In the following, the advantageous effects of the exemplary embodiment are described using FIG. 8A to FIG. 10C.

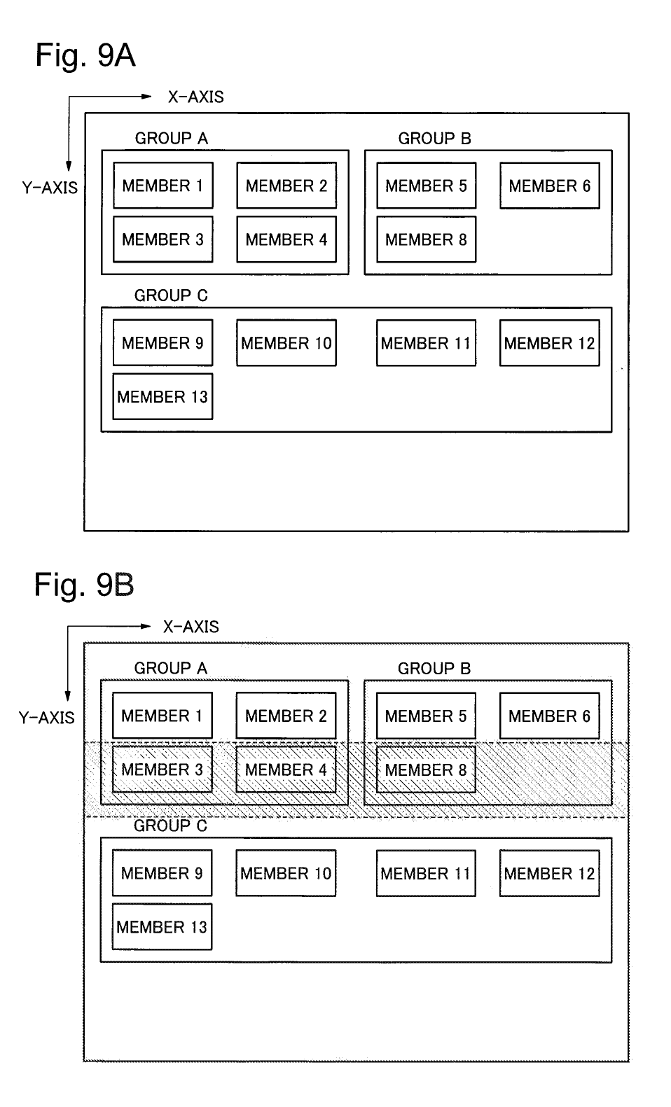

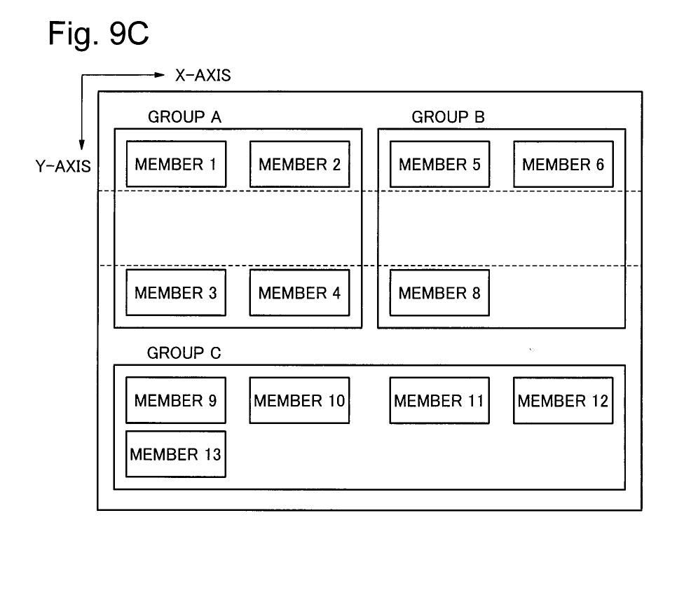

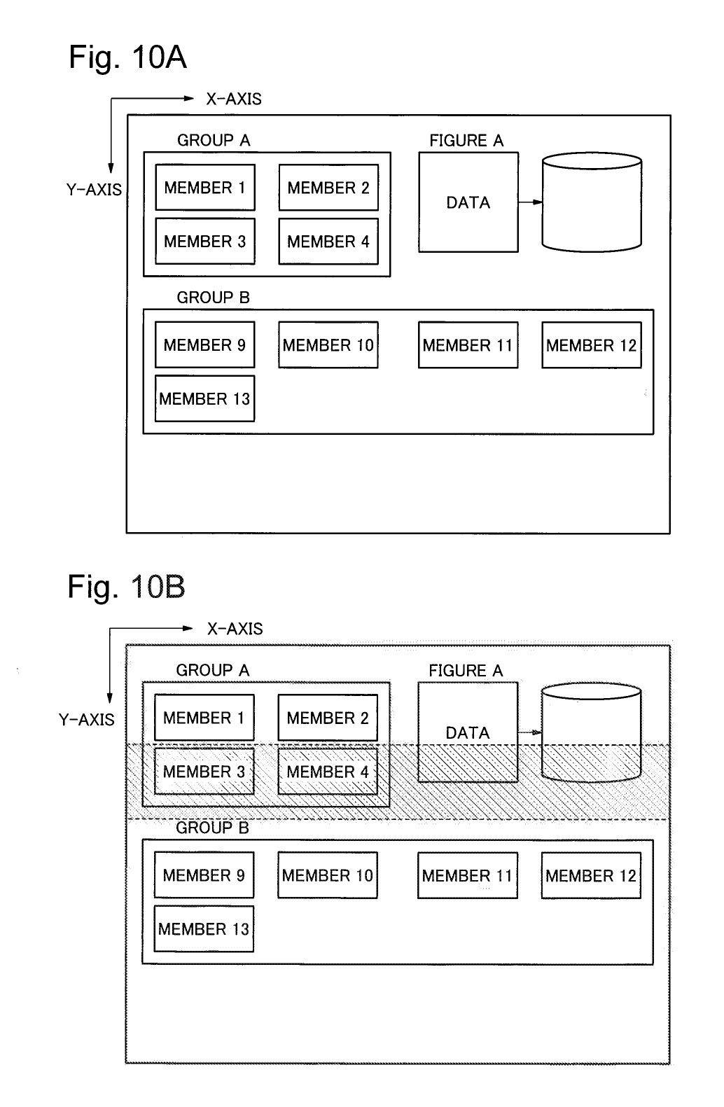

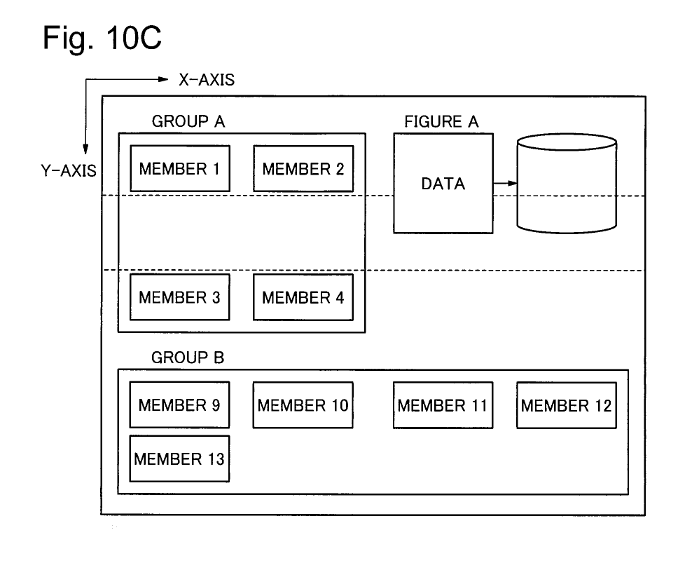

FIG. 8A, FIG. 8B, and FIG. 8C are diagrams illustrating a general space insertion process used in a White board system such as OneNote (registered trademark) which is a product developed by Microsoft cooperation. FIG. 8A, FIG. 8B, and FIG. 8C respectively illustrate a series of processes. FIG. 9A, FIG. 9B, and FIG. 9C are diagrams illustrating an example of a space insertion process in the exemplary embodiment of the invention. FIG. 9A, FIG. 9B, and FIG. 9C respectively illustrate a series of processes. FIG. 10A, FIG. 10B, and FIG. 10C are diagrams illustrating an example of a space insertion process in the exemplary embodiment of the invention. FIG. 10A, FIG. 10B, and FIG. 10C respectively illustrate a series of processes. In any of these drawings, the right direction is defined as the x-axis positive direction, and the down direction is defined as the y-axis positive direction, as in FIG. 5A and FIG. 5B.

When the user intends to insert a space within the frame of the group A on a drawn electronic whiteboard as illustrated in FIG. 8A, the user designates a range of space insertion in the y-axis positive direction as illustrated in FIG. 8B. In this case, the frame object is moved by the designated distance. As a result, as illustrated in FIG. 8C, the objects within the frame come out of the frame, and it is difficult for the user to insert an appropriate space within the frame of the group A.

Also in the exemplary embodiment, when the user intends to insert a space in the center within the frame of the group A and within the frame of the group B on a drawn electronic whiteboard as illustrated in FIG. 9A, the user may designate a range for space insertion along the y-axis positive direction as illustrated in FIG. 9B. In this case, in the exemplary embodiment, it is discriminated that the object of the group A and the object of the group B are used as a frame. Therefore, as illustrated in FIG. 9C, the frame object of the group A and the frame object of the group B are appropriately enlarged, and a space is inserted within the frame of the group A and within the frame of the group B.

Further, as illustrated in FIG. 10A, various kinds of objects may be drawn on an electronic whiteboard. In this case, as illustrated in FIG. 10B, the user designates a range of space insertion along the y-axis positive direction in order to insert a space at a lower portion within the frame of the group A. In this case, in the exemplary embodiment, it is discriminated that the object of the group A is used as a frame. Therefore, as illustrated in FIG. 10C, the object representing the group A is enlarged, and a space is inserted within the frame of the group A. On the other hand, as illustrated in FIG. 10C, it is discriminated that the objects described in the lower portion of the figure A are not a frame. Therefore, an enlargement process is not applied to the objects.

### First Modification

In the exemplary embodiment, the electronic whiteboard device 100 may be a device for providing an electronic whiteboard on a network. In this configuration, the electronic whiteboard device 100 is connected to a terminal device used by a user via a network. Further, in this configuration, an input device of the terminal device used by the user functions as an input device 40, and a display device of the terminal device functions as a display device 50.

Further, in this configuration, a plurality of terminal devices may be connected to the electronic whiteboard device 100. In this case, a plurality of users can share information on an electronic whiteboard via each of the terminal devices. Further, in this configuration, an object setting unit 11 places objects such as a frame object in accordance with an instruction from a terminal device. Further, a space insertion processing unit 13 receives a request of space insertion from the terminal device.

As described above, in the first modification of the exemplary embodiment, it is not essentially required to physically provide an electronic whiteboard device 100. Therefore, it is possible to remote control the electronic whiteboard device 100 from different places via a network.

### Second Modification

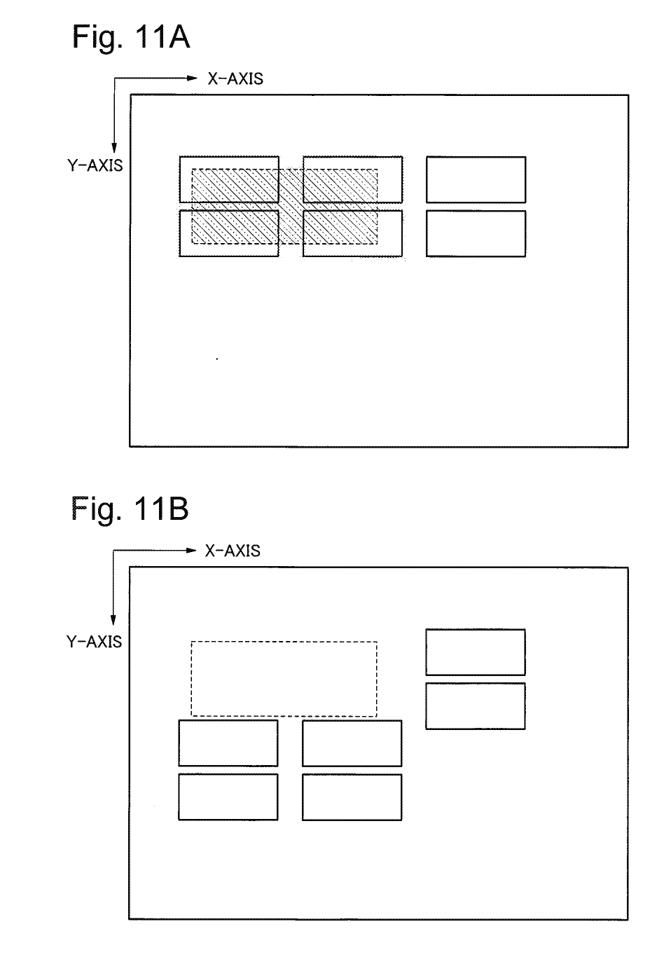

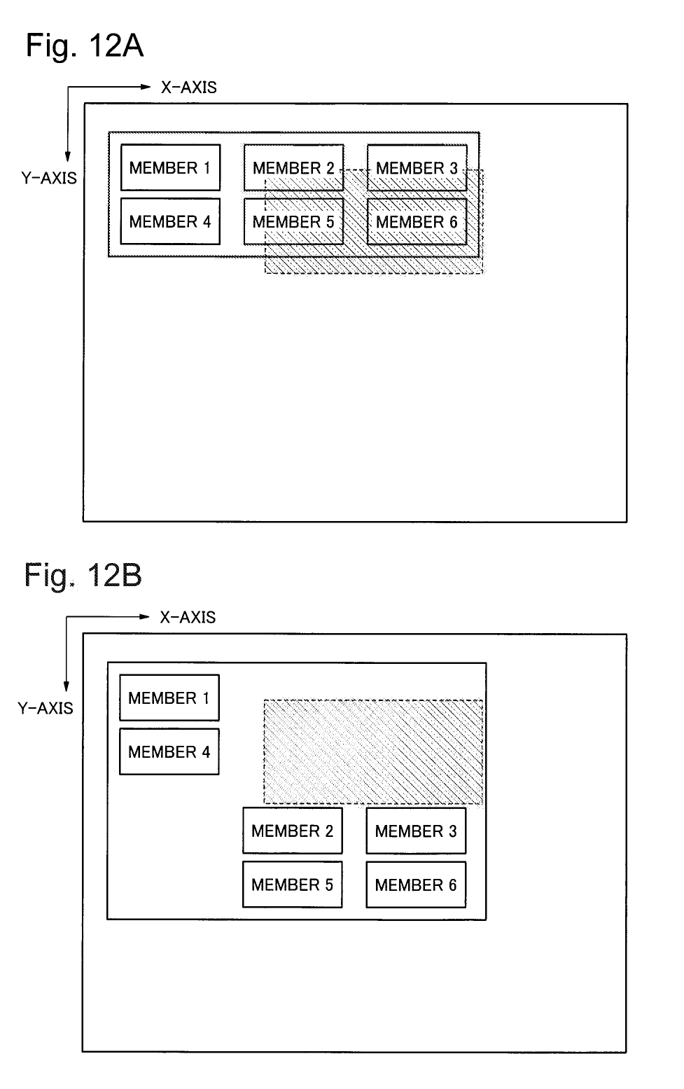

In the aforementioned example, space designation is performed based on designating two points along the y-axis. The exemplary embodiment is not limited to the aforementioned configuration. This is described using FIG. 11A to FIG. 12B. FIG. 11A and FIG. 11B are diagrams illustrating an example of a variation of space insertion, and respectively illustrate a series of processes. FIG. 12A and FIG. 12B are diagrams illustrating another example of a variation of space insertion, and respectively illustrate a series of processes. In any of these drawings, the right direction is defined as the x-axis positive direction, and the down direction is defined as the y-axis positive direction, as in FIG. 5A and FIG. 5B.

For instance, as illustrated in FIG. 11A, the user is allowed to perform space insertion by designating a rectangular area by input of two points on a screen. In this case, a drag start point is not located on a frame object. Therefore, as illustrated in FIG. 11B, a space insertion processing unit 13 moves all the objects overlapping the designated rectangular area in the y-axis positive direction.

In FIG. 12A, the user is also allowed to perform space insertion by designating a rectangular area by input of two points on a screen. In this case, a drag start point is located on a frame object. Therefore, as illustrated in FIG. 12B, first of all, the space insertion processing unit 13 moves all the objects intersecting with the designated rectangular area in the y-axis positive direction. Then, the space insertion processing unit 13 enlarges the frame object to a minimum size enough to include both of the moved objects and the designated rectangular area.

The second modification may also be applied to a case, in which the moving direction of an object and the enlarging direction of a frame object coincide with the x-axis positive direction (the right direction).

According to the aforementioned configuration, in the second modification of the exemplary embodiment, the user can freely set the moving direction of an object and the enlarging direction of a frame object. Alternatively, the moving direction of an object and the enlarging direction of a frame object may be set by a designer of the electronic whiteboard device. In the latter case, it is possible to specify, for instance, the length of a moving distance in each direction and a direction in which a space exists in the electronic whiteboard device, and to set the moving direction of an object and the enlarging direction of a frame object based on these parameters.

### Third Modification

When another object already exists in a moving destination or in an enlargement destination in moving or enlarging an object at the time of space insertion, a space insertion processing unit 13 may further move the another object in the y-axis positive direction or in the x-axis positive direction.

Specifically, when another object already exists in a moving destination, the space insertion processing unit 13 repeatedly executes a process of moving the another object in the y-axis positive direction (the down direction) or in the x-axis positive direction (the right direction) until the another object does not exist in the moving destination. Also in the third modification, the user may freely set the moving direction of an object and the enlarging direction of a frame object, or may set in advance the moving direction of an object and the enlarging direction of a frame object in the electronic whiteboard device.

According to the aforementioned configuration, in the third modification of the exemplary embodiment, when another object already exists in a moving destination or in an enlargement destination of an object at the time of space insertion, the space insertion processing unit 13 may further move the another object in the y-axis positive direction or in the x-axis positive direction. This eliminates the need of deleting an existing object.

### Applied Example

The exemplary embodiment is useful, for instance, when a plurality of participants freely write their ideas on an electronic whiteboard, group by group, in each of the technical fields in a new product planning meeting. In this case, when the electronic whiteboard is full of writing or notes, and it is necessary to insert the space, it is possible to effectively insert the space.

The exemplary embodiment is useful, for instance, when it is necessary to additionally write a client request for a product on an electronic whiteboard on which the client requests are collected, while grouping the client requests for each of the functions of the product, each time a client request for the product is received. In this case, when the electronic whiteboard is full of writing or notes, and it is necessary to insert the space, it is possible to effectively insert the space.

### Program

The program in the exemplary embodiment may be a program that executes Steps A1 to A7 illustrated in FIG. 4, and Steps B1 to B10 illustrated in FIG. 7. Installing the program on a computer for execution makes it possible to implement the electronic whiteboard device and the input support method of an electronic whiteboard in the exemplary embodiment. In this case, the CPU (Central Processing Unit) of the computer functions as the object setting unit 11, the frame object discriminating unit 12, the space insertion processing unit 13, and the edit process discriminating unit 14. The CPU carries out the processes.

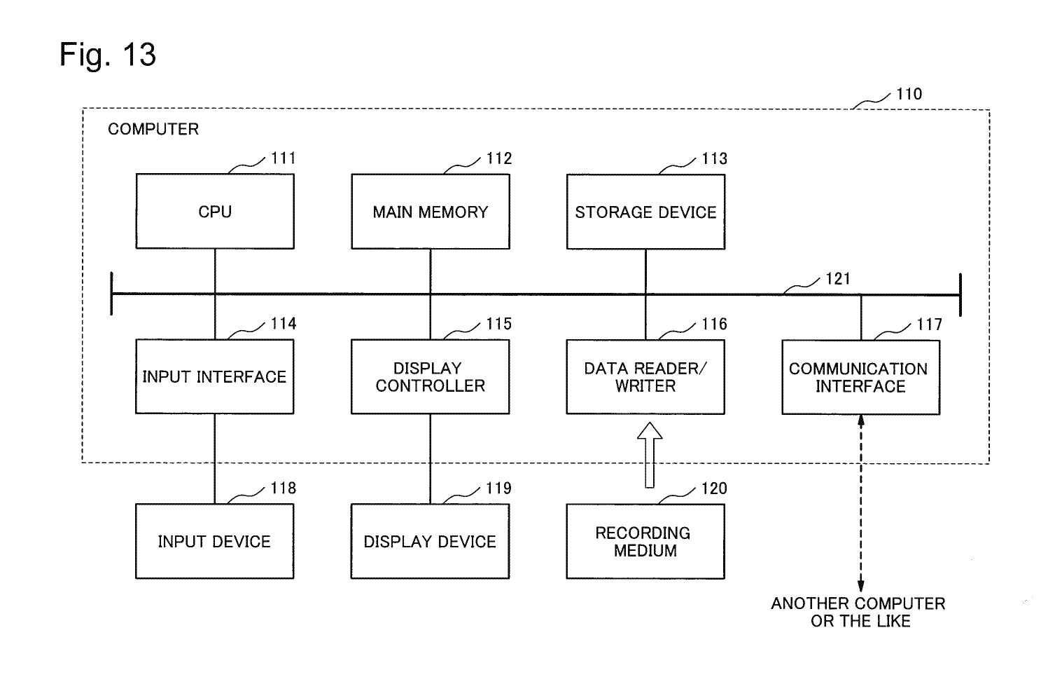

A computer that implements the electronic whiteboard device 100 by executing the program in the exemplary embodiment is described using FIG. 13. FIG. 13 is a block diagram illustrating an example of a computer that implements the electronic whiteboard device in the exemplary embodiment of the invention.

As illustrated in FIG. 13, a computer 110 is provided with a CPU 111, a main memory 112, a storage device 113, an input interface 114, a display controller 115, a data reader/writer 116, and a communication interface 117. These units are connected to each other via a bus 121 so that data communication is enabled between these units.

The CPU 111 develops the program (codes) in the exemplary embodiment, which is stored in the storage device 113, in the main memory 112, and executes the program codes by a predetermined order for implementing various computations. The main memory 112 is typically a volatile storage device such as a DRAM (Dynamic Random Access Memory). Further, the program in the exemplary embodiment is provided in a state that the program is stored in a computer-readable recording medium 120. The program in the exemplary embodiment may be distributed on the Internet connected to the computer via the communication interface 117.

Practical examples of the storage device 113 include a semiconductor storage device such as a flash memory, in addition to a hard disk drive. The input interface 114 mediates data transmission between the CPU 111, and input devices 118 such as a keyboard and a mouse. The display controller 115 is connected to a display device 119, and controls display on the display device 119.

The data reader/writer 116 mediates data transmission between the CPU 111 and the recording medium 120, and executes reading of a program from the recording medium 120, and writing of a processing result in the computer 110 to the recording medium 120. The communication interface 117 mediates data transmission between the CPU 111 and another computer.

Further, practical examples of the recording medium 120 may include a versatile semiconductor storage device such as a CF (Compact Flash (registered trademark)) device and a SD (Secure Digital) device, a magnetic recording medium such as a flexible disk, and an optical recording medium such as a CD-ROM (Compact Disk Read Only Memory).

Part or all of the exemplary embodiment may be described as the following Supplemental Notes (1) to (15). The present invention described by the exemplary embodiment, however, is not limited to the following.

(Supplemental Note 1) An electronic whiteboard device, comprising:

an object setting unit which places a frame object for use in grouping information on an electronic whiteboard displayed on a screen;

a frame object discriminating unit which discriminates whether an object existing in an area for which space insertion is requested on the electronic whiteboard is the frame object; and

a space insertion processing unit which enlarges the discriminated frame object in accordance with a space to be inserted, and changes a display position of the discriminated frame object so that the enlarged frame object does not overlap another object placed in a vicinity of the frame object.

(Supplemental Note 2) The electronic whiteboard device according to Note 1 or 2, wherein

the frame object discriminating unit discriminates that a target object that satisfies all the following conditions is the frame object, the conditions being such that:

the shape of the target object is rectangle;

the area of the target object is equal to or smaller than a threshold value;

the number of objects placed within the target object exceeds a threshold number; and

a ratio of objects of the same kind among the objects placed within the target object is equal to or larger than a threshold value.

(Supplemental Note 3) The electronic whiteboard device according to at least one of Note 1-3, wherein

when the space insertion is performed by designating two points on the screen, the space insertion processing unit specifies an object that overlaps an area defined by the designated two points, and

the frame object discriminating unit determines whether the specified object is the frame object.

(Supplemental Note 4) The electronic whiteboard device according to at least one of Note 1-3, wherein

when the space insertion is performed by designating two points on the screen, the space insertion processing unit enlarges the frame object by a distance between the designated two points in a setting direction.

(Supplemental Note 5) The electronic whiteboard device according to at least one of Note 1-3, wherein

when the space insertion is performed by designating a rectangular area by input of two points on the screen, the space insertion processing unit enlarges the discriminated frame object in such a manner that the rectangular area is included in the enlarged frame object.

(Supplemental Note 6) The electronic whiteboard device according to at least one of Note 1-5, wherein

the electronic whiteboard device is connected to a terminal device via a network,

the object setting unit places the frame object in accordance with an instruction from the terminal device, and

the space insertion processing unit receives a request of the space insertion from the terminal device.

(Supplemental Note 7) An input support method of an electronic whiteboard, comprising:

(a) placing a frame object for use in grouping information on an electronic whiteboard displayed on a screen;

(b) discriminating whether an object existing in an area for which space insertion is requested on the electronic whiteboard is the frame object; and

(c) enlarging the frame object discriminated in the step (b) in accordance with a space to be inserted, and changing a display position of the frame object in such a manner that the enlarged frame object does not overlap another object placed in a vicinity of the frame object.

(Supplemental Note 8) The input support method of an electronic whiteboard according to Note 7, wherein

in the step (b), it is discriminated that a target object that satisfies all the following conditions is the frame object, the conditions being such that:

the shape of the target object is rectangle;

the area of the target object is equal to or smaller than a threshold value;

the number of objects placed within the target object exceeds a threshold number; and

a ratio of objects of the same kind among the objects placed within the target object is equal to or larger than a threshold value.

(Supplemental Note 9) The input support method of an electronic whiteboard according to Note 7 or 8, further comprising:

(d) when the space insertion is performed by designating two points on the screen, specifying an object that overlaps an area defined by the designated two points, wherein

in the step (b), it is discriminated whether the object specified in the step (d) is the frame object.

(Supplemental Note 10) The input support method of an electronic whiteboard according to at least one of Note 7-9, wherein

when the space insertion is performed by designating two points on the screen, in the step (c), the frame object is enlarged by a distance between the designated two points in a setting direction.

(Supplemental Note 11) The input support method of an electronic whiteboard according to at least one of Note 7-9, wherein

when the space insertion is performed by designating a rectangular area by input of two points on the screen, in the step (c), the discriminated frame object is enlarged in such a manner that the rectangular area is included in the enlarged frame object.

(Supplemental Note 12) A non-transitory computer-readable recording medium storing a program which causes a computer to execute:

(a) placing a frame object for use in grouping information on an electronic whiteboard displayed on a screen;

(b) discriminating whether an object existing in an area for which space insertion is requested on the electronic whiteboard is the frame object; and

(c) enlarging the frame object discriminated in the step (b) in accordance with a space to be inserted, and changing a display position of the frame object in such a manner that the enlarged frame object does not overlap another object placed in a vicinity of the frame object.

(Supplemental Note 13) The recording medium according to Note 12, wherein

in the step (b), it is discriminated that a target object that satisfies all the following conditions is the frame object, the conditions being such that:

the shape of the target object is rectangle;

the area of the target object is equal to or smaller than a threshold value;

the number of objects placed within the target object exceeds a threshold number; and

a ratio of objects of the same kind among the objects placed within the target object is equal to or larger than a threshold value.

(Supplemental Note 14) The recording medium according to Note 12 or 13, wherein

when the space insertion is performed by designating two points on the screen, the program causes the computer to further execute:

(d) specifying an object that overlaps an area defined by the designated two points; and

in the step (b), it is discriminated whether the object specified in the step (d) is the frame object.

(Supplemental Note 15) The recording medium according to at least one of Note 12-14, wherein

when the space insertion is performed by designating two points on the screen, in the step (c), the discriminated frame object is enlarged by a distance between the designated two points in a setting direction.

(Supplemental Note 16) The recording medium according to at least one of Note 12-14, wherein

when the space insertion is performed by designating a rectangular area by input of two points on the screen, in the step (c), the discriminated frame object is enlarged in such a manner that the rectangular area is included in the enlarged frame object.

As described above, according to the invention, it is possible to automatically execute position adjustment between a frame object and another object, while allowing a user to insert a space within the frame object by a simplified operation on an electronic whiteboard. The invention is useful for a variety of electronic whiteboards.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

### REFERENCE SIGNS LIST

10 Edit processing unit
11 Object setting unit
12 Frame object discriminating unit
13 Space insertion processing unit
14 Edit process discriminating unit
20 Storage unit
30 Display unit
40 Input device
50 Display device
100 Electronic whiteboard device
110 Computer
111 CPU
112 Main memory
113 Storage device
114 Input interface
115 Display controller
116 Data reader/writer
117 Communication interface
118 Input device
119 Display device
120 Recording medium
121 Bus

1. An electronic whiteboard device, comprising:
an object setting unit which places a frame object for use in grouping information on an electronic whiteboard displayed on a screen;
a frame object discriminating unit which discriminates whether an object existing in an area for which space insertion is requested on the electronic whiteboard is the frame object; and
a space insertion processing unit which enlarges the discriminated frame object in accordance with a space to be inserted, and changes a display position of the discriminated frame object so that the enlarged frame object does not overlap another object placed in a vicinity of the frame object.

2. The electronic whiteboard device according to claim 1, wherein
the frame object discriminating unit discriminates that a target object that satisfies all the following conditions is the frame object, the conditions being such that:
the shape of the target object is rectangle;
the area of the target object is equal to or smaller than a threshold value;
the number of objects placed within the target object exceeds a threshold number; and
a ratio of objects of the same kind among the objects placed within the target object is equal to or larger than a threshold value.

3. The electronic whiteboard device according to claim 1, wherein
when the space insertion is performed by designating two points on the screen, the space insertion processing unit specifies an object that overlaps an area defined by the designated two points, and
the frame object discriminating unit determines whether the specified object is the frame object.

4. The electronic whiteboard device according to claim 1, wherein
when the space insertion is performed by designating two points on the screen, the space insertion processing unit enlarges the frame object by a distance between the designated two points in a setting direction.

5. The electronic whiteboard device according to claim 1, wherein
when the space insertion is performed by designating a rectangular area by input of two points on the screen, the space insertion processing unit enlarges the discriminated frame object in such a manner that the rectangular area is included in the enlarged frame object.

6. The electronic whiteboard device according to claim 1, wherein
the electronic whiteboard device is connected to a terminal device via a network,
the object setting unit places the frame object in accordance with an instruction from the terminal device, and
the space insertion processing unit receives a request of the space insertion from the terminal device.

7. An input support method of an electronic whiteboard, comprising:
(a) placing a frame object for use in grouping information on an electronic whiteboard displayed on a screen;
(b) discriminating whether an object existing in an area for which space insertion is requested on the electronic whiteboard is the frame object; and
(c) enlarging the frame object discriminated in the step (b) in accordance with a space to be inserted, and changing a display position of the frame object in such a manner that the enlarged frame object does not overlap another object placed in a vicinity of the frame object.

8. The input support method of an electronic whiteboard according to claim 7, wherein
in the step (b), it is discriminated that a target object that satisfies all the following conditions is the frame object, the conditions being such that:
the shape of the target object is rectangle;
the area of the target object is equal to or smaller than a threshold value;
the number of objects placed within the target object exceeds a threshold number; and
a ratio of objects of the same kind among the objects placed within the target object is equal to or larger than a threshold value.

9. The input support method of an electronic whiteboard according to claim 7, further comprising:
(d) when the space insertion is performed by designating two points on the screen, specifying an object that overlaps an area defined by the designated two points, wherein
in the step (b), it is discriminated whether the object specified in the step (d) is the frame object.

10. The input support method of an electronic whiteboard according to claim 7, wherein
when the space insertion is performed by designating two points on the screen, in the step (c), the frame object is enlarged by a distance between the designated two points in a setting direction.

11. The input support method of an electronic whiteboard according to claim 7, wherein
when the space insertion is performed by designating a rectangular area by input of two points on the screen, in the step (c), the discriminated frame object is enlarged in such a manner that the rectangular area is included in the enlarged frame object.

12. A non-transitory computer-readable recording medium storing a program which causes a computer to execute:
(a) placing a frame object for use in grouping information on an electronic whiteboard displayed on a screen;
(b) discriminating whether an object existing in an area for which space insertion is requested on the electronic whiteboard is the frame object; and
(c) enlarging the frame object discriminated in the step (b) in accordance with a space to be inserted, and changing a display position of the frame object in such a manner that the enlarged frame object does not overlap another object placed in a vicinity of the frame object.

13. The recording medium according to claim 12, wherein
in the step (b), it is discriminated that a target object that satisfies all the following conditions is the frame object, the conditions being such that:
the shape of the target object is rectangle;
the area of the target object is equal to or smaller than a threshold value;
the number of objects placed within the target object exceeds a threshold number; and
a ratio of objects of the same kind among the objects placed within the target object is equal to or larger than a threshold value.

14. The recording medium according to claim 12, wherein
when the space insertion is performed by designating two points on the screen, the program causes the computer to further execute:
(d) specifying an object that overlaps an area defined by the designated two points; and
in the step (b), it is discriminated whether the object specified in the step (d) is the frame object.

15. The recording medium according to claim 12, wherein
when the space insertion is performed by designating two points on the screen, in the step (c), the discriminated frame object is enlarged by a distance between the designated two points in a setting direction.

16. The recording medium according to claim 12, wherein
when the space insertion is performed by designating a rectangular area by input of two points on the screen, in the step (c), the discriminated frame object is enlarged in such a manner that the rectangular area is included in the enlarged frame object.
